(19) United States
(12) Patent Application Publication
(10) Pub. No.: US 2006/0011032 A1
(43) Pub. Date: Jan. 19, 2006

(54) Guarded power circular saw assembly

(76) Inventors: Warren Gibson James Brown, Cheltenham (AU); Harry Walter Paul Szommer, Cheltenham (AU)

Correspondence Address: KLAUBER & JACKSON, 411 HACKENSACK AVENUE, HACKENSACK, NJ, 07601, US

(21) Appl. No.: 10/529,611

(22) PCT Filed: Sep. 30, 2003
(86) PCT No.: PCT/AU03/01278

§ 371 Date: Sep. 7, 2005

(30) Foreign Application Priority Data
Sep. 30, 2002 (AU) 2002951716

(51) Int. Cl. B23D 19/00

(52) U.S. Cl. 83/471.2; 83/477.2; 83/478; 83/491; 83/698.41

(57) ABSTRACT

A guarded power saw assembly (10) that ensures that a blade (58) is always positioned out of reach of the operator is disclosed. The assembly (10) includes: a base (30) for supporting a work-piece; a circular saw blade (58); a drive motor operatively connected to the saw blade (58); a head (20) supporting both the drive motor and the saw blade (58), with the head mounted to the base for movement through an arc about a primary pivot axis from a raised position above the base to a lowered position engaging the base; an arm (50) having an end mounted to the head (20) for movement through an arc about a secondary pivot axis and another end supporting the blade (58); a locking means operatively interposed between the head (20) and arm (50), the locking means having a locked condition in which the arm (50) is locked to the head (20) so as to keep the saw blade (58) enclosed by the head (20) and an unlocked position in which the arm (50) is pivotally movable with respect to the head (20) to allow a portion of the blade (58) to exit the head (20); and a handle (40) extending from the head (20) and operatively connected to the arm (50). The handle (40) is movable to first rotate the locked together head (20) and arm (50) with respect to the base (30) towards the work-piece and, after the head (20) has engaged the base (30), to then pivot the arm (50) with respect to the head (20) such that the blade (58) exits the head (20) to cut the work-piece.

### BACKGROUND TO THE INVENTION

This invention relates to power circular saws and in particular to power circular saws that are pivotally moveable with respect to a base or work-piece support surface. These types of saws are sometimes referred to as “drop saws”.

The following discussion providing some background to the invention is intended to facilitate a better understanding of the invention. However, it should be appreciated that the discussion is not an acknowledgement or admission that any of the material referred to was published, known or part of the common general knowledge in Australia as at the priority date of the application.

Conventional drop saws provide little, or no protection to the operator from injury by the cuffing blade. While drop saws are often equipped with blade guards, these guards generally retract progressively as the saw is lowered towards the base or work-piece support surface. Exposure of the cutting blade makes it possible for the operator to inadvertently place his hands or fingers in the path of the saw.

It is an object of the invention to provide a guarded power circular saw assembly that reduces the likelihood of injury to the operator. More particularly, it is an object of the invention to keep the blade fully guarded during cutting operations.

### SUMMARY OF THE INVENTION

According to the invention there is provided a guarded power saw assembly comprising:

a base for supporting a work-piece;

a circular saw blade;

a drive motor operatively connected to the saw blade;

a head supporting both the drive motor and the saw blade, with the head mounted to the base for movement through an arc about a primary pivot axis from a raised position above the base to a lowered position engaging the base;

an arm having a proximal end and a distal end, the proximal end mounted to the head for movement through an arc about a secondary pivot axis and the distal end supporting the circular saw blade;

a first locking means operatively interposed between the head and arm, the first locking means having a locked condition in which the arm is locked to the head so as to keep the saw blade enclosed by the head and an unlocked position in which the arm is pivotally movable with respect to the head to allow a portion of the blade to exit the head; and

a handle extending from the head and operatively connected to the arm,

wherein the handle is movable to first rotate the locked together head and arm with respect to the base towards the work-piece and, after the head has engaged the base, to then pivot the arm with respect to the head such that the saw blade exits the head to cut the work-piece.

Preferably the assembly further comprises a second locking means operatively interposed between the head and the base, the second locking means having an unlocked condition in which the head is pivotally movable with respect to the base and having a locked condition in which the head is locked to the base after the head has engaged the base and the arm has commenced rotation with respect to the head.

Preferably the assembly further comprises an intermediate locking means operatively interposed between the head and the arm, the intermediate locking means operable to lock the arm to the head when an attempt is made to lift the head away from engagement with the base,

wherein the intermediate locking means is operable after the first locking means has unlocked and prior to the second locking means engaging.

Preferably the base has a work-piece receiving recessed channel, the channel defined by a pair of spaced apart parallel first and second channel walls joined at their lower sides by a channel floor,

wherein the channel is longitudinally disposed perpendicular to the plane of the blade.

Preferably the assembly includes a work-piece clamp assembly and, after initial pre-adjustment of the clamp assembly, the clamp assembly is automatically actuated as the head is lowered towards the work-piece.

Preferably the clamp assembly comprises:

a pair of work-piece clamps each slidably mounted for movement across the channel through respective spaced apart slots in the first channel wall towards the second channel wall, the clamps spaced apart for clamping the work-piece on respective sides of the blade; and

a pair of respective clamp mechanisms, each operably connected between the head and its respective clamp,

whereby, as the head is lowered towards the base, the clamp mechanisms move the clamps across the channel to clamp a work-piece located in the channel.

Preferably each clamp mechanism comprises:

a linkage assembly operably connecting the clamp to the head; and

an adjusting means for adjusting the position of the clamp with respect to the linkage assembly in a direction across the channel,

wherein the adjusting means of a first of the clamp mechanisms allow its clamp to be moved to a pre-adjusted position adjacent or abutting the work-piece and the adjusting means of a second of the clamp mechanisms allow its clamp to be moved to a pre-adjusted position adjacent or abutting the work-piece or the second channel wall.

Preferably the assembly further comprises a work-piece clamp interlock means for preventing the commencement of sawing,

wherein the interlock means disengages to allow the commencement of sawing as the locked together head and arm rotates towards the work-piece only when both work-piece clamps have been moved to their pre-adjusted positions.

Preferably each linkage assembly comprises:

a first portion;

a second portion overlapping the first portion to define an overlapping portion; and

a compression spring mounted within the overlapping portion for compression when the pre-adjusted clamp is actuated to engage a work-piece or the second channel wall.

Preferably the interlock means comprises a blocking means for preventing the head being lowered sufficiently towards the base to allow disengagement of the first locking means, the blocking means having a blocking surface operably connected the second portion of the linkage assembly,

wherein, in use, if both clamps are not in their said pre-adjusted positions, the blocking surface moves to a position preventing the head being lowered sufficiently towards the base to allow disengagement of the first locking means.

Preferably the blocking means further comprises a pin positioned between the head and the blocking surface, the blocking pin held up by the blocking surface to prevent the head being lowered sufficiently towards the base to allow disengagement of the first locking means when either clamps is not in its said pre-adjusted position.

Preferably the head has a removable cover shaped to guard the blade.

Preferably the primary and secondary pivot axes are parallel and spaced apart.

Specific embodiments of the invention will now be described in some further detail with reference to and as illustrated in the accompanying figures. These embodiments are illustrative, and are not meant to be restrictive of the scope of the invention.

### DETAILED DESCRIPTION OF PREFERRED EMBODIMENTS OF THE INVENTION

Preferred embodiments of the invention are illustrated in the accompanying figures in which:

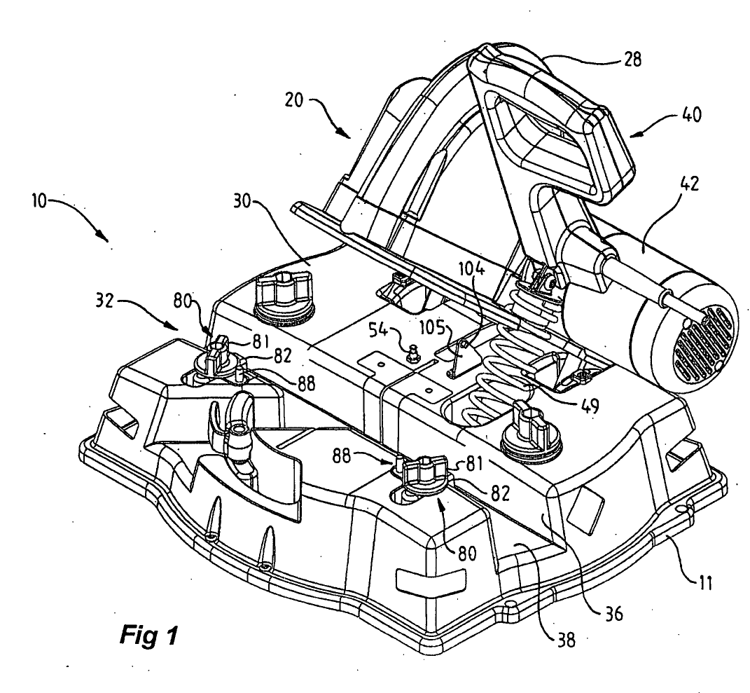

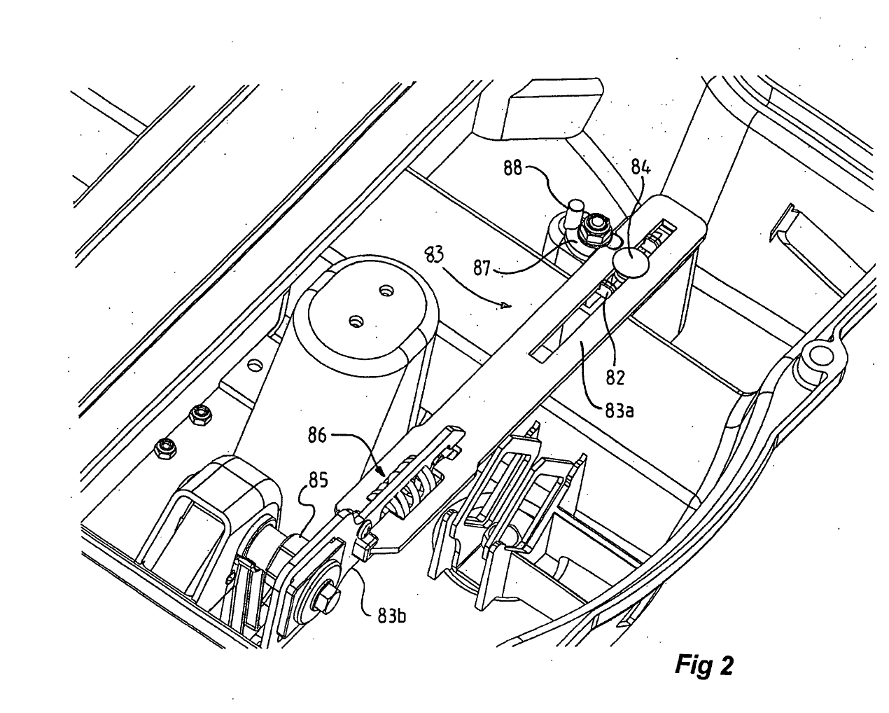

FIG. 1 shows a perspective view of a guarded power circular saw assembly according to a first embodiment of the invention with its head up and the blade still in its raised position.

FIG. 2 shows the saw of FIG. 1 from underneath.

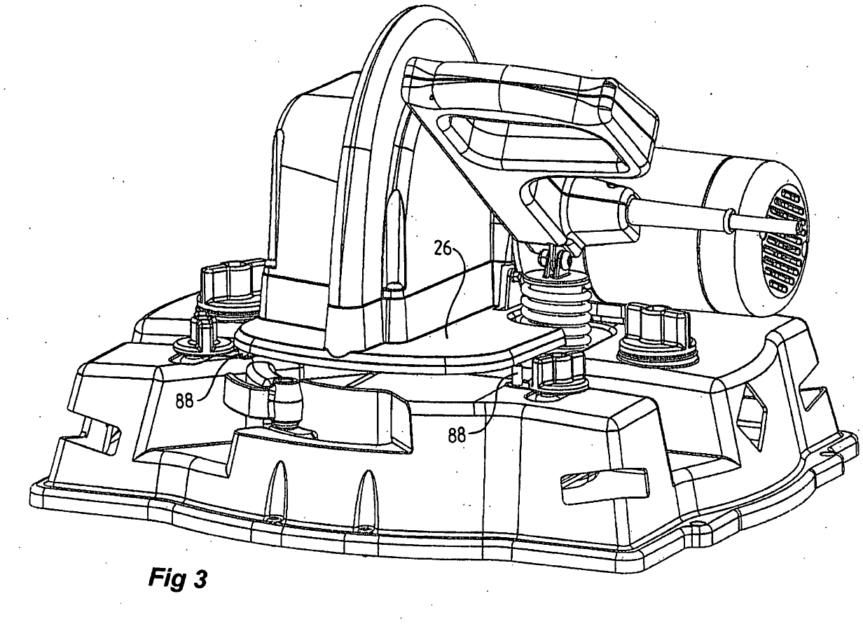

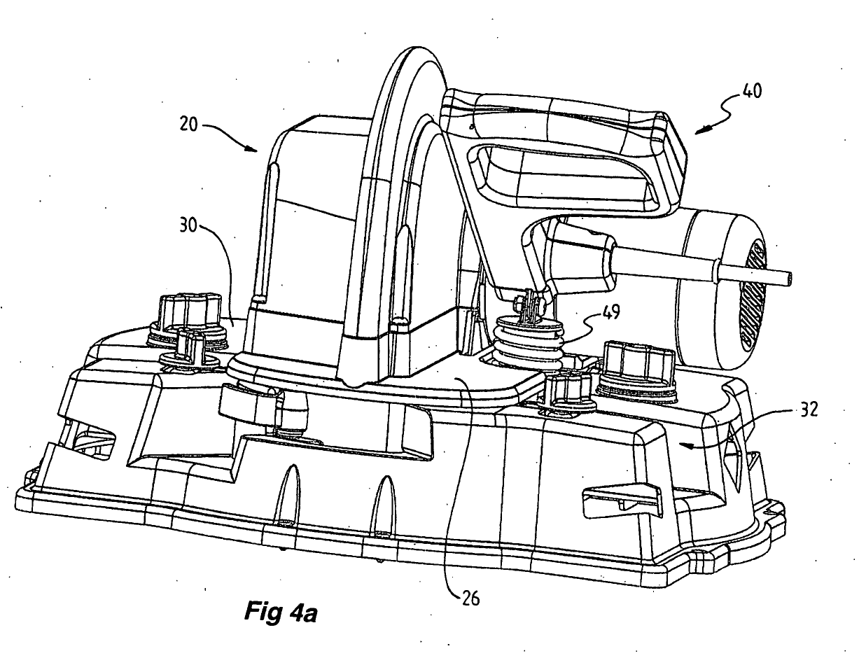

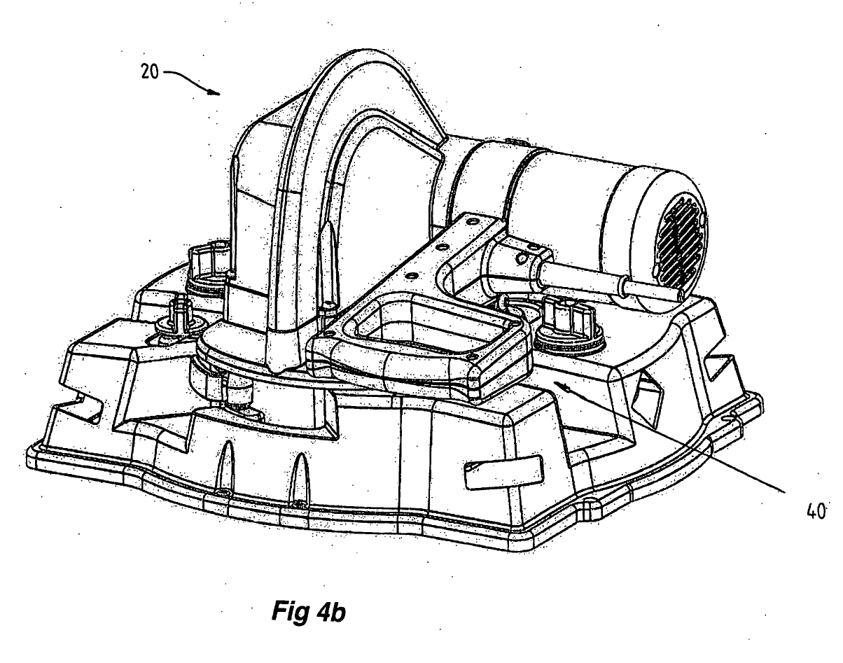

FIGS. 3, 4a and 4b show the saw of FIG. 1 with its head being progressively lowered to the fully lowered position shown in FIG. 4a and then the handle being lowered to the fully lowered position shown in FIG. 4b.

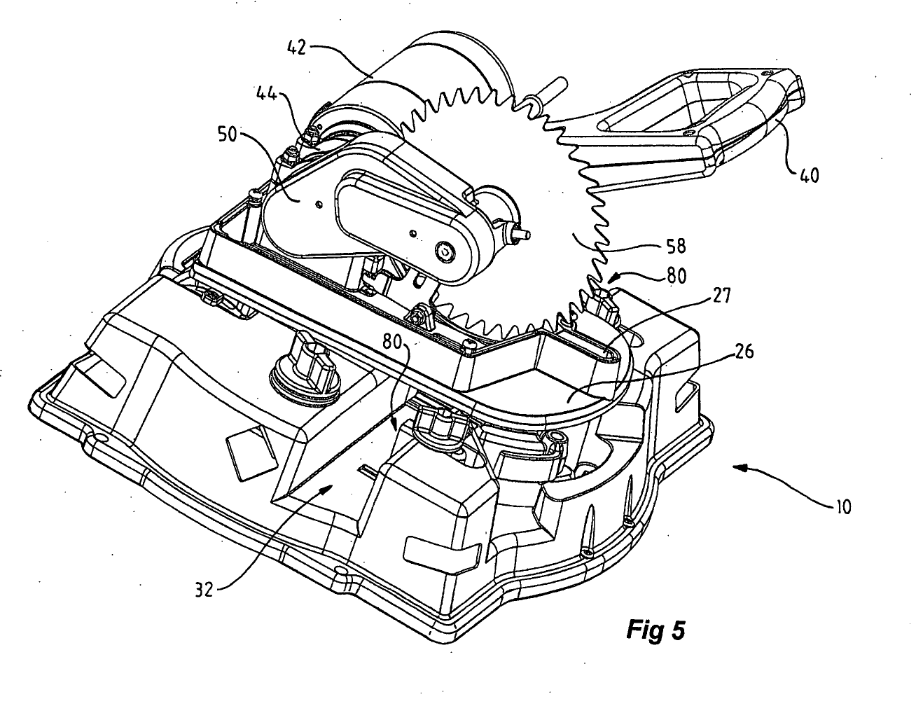

FIG. 5 shows the saw of FIG. 1 with its blade cover removed to show the cutting blade.

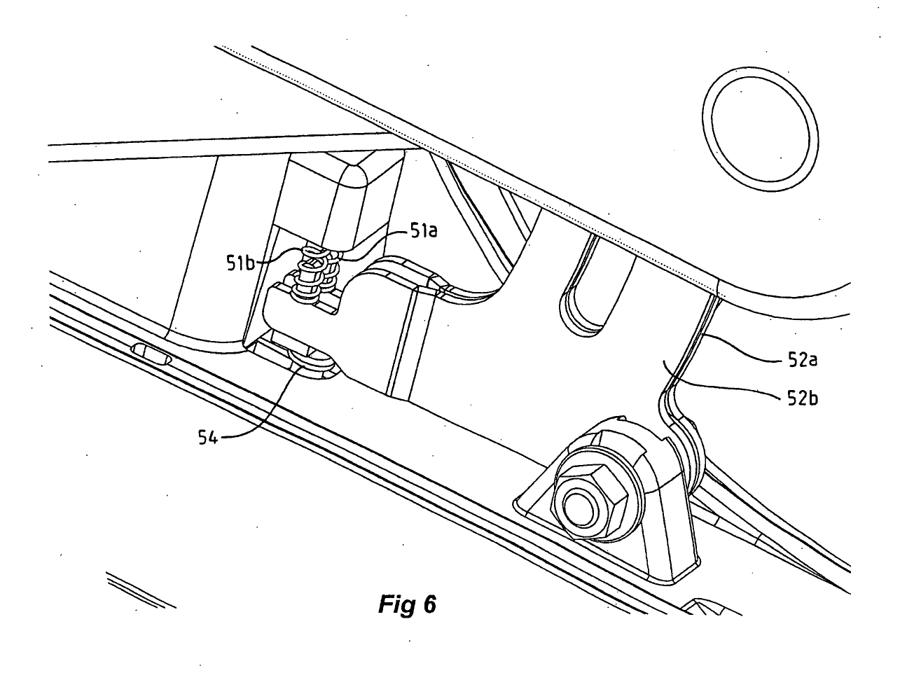

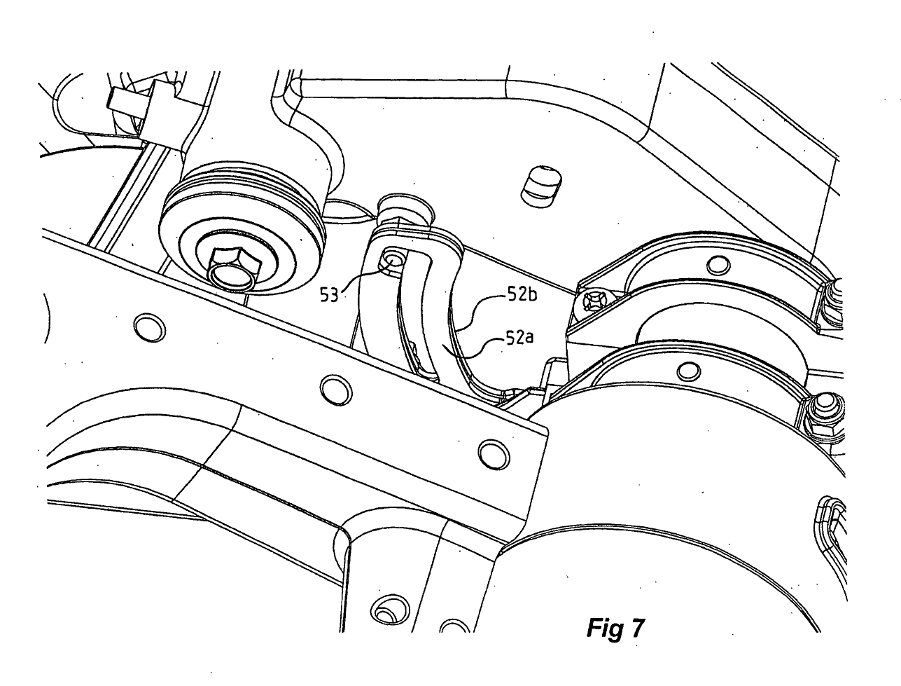

FIGS. 6 and 7 show a detailed perspective view of a first locking means for locking the movement of the drive arm with respect to the head. These Figs show the first locking means in a fully locked condition.

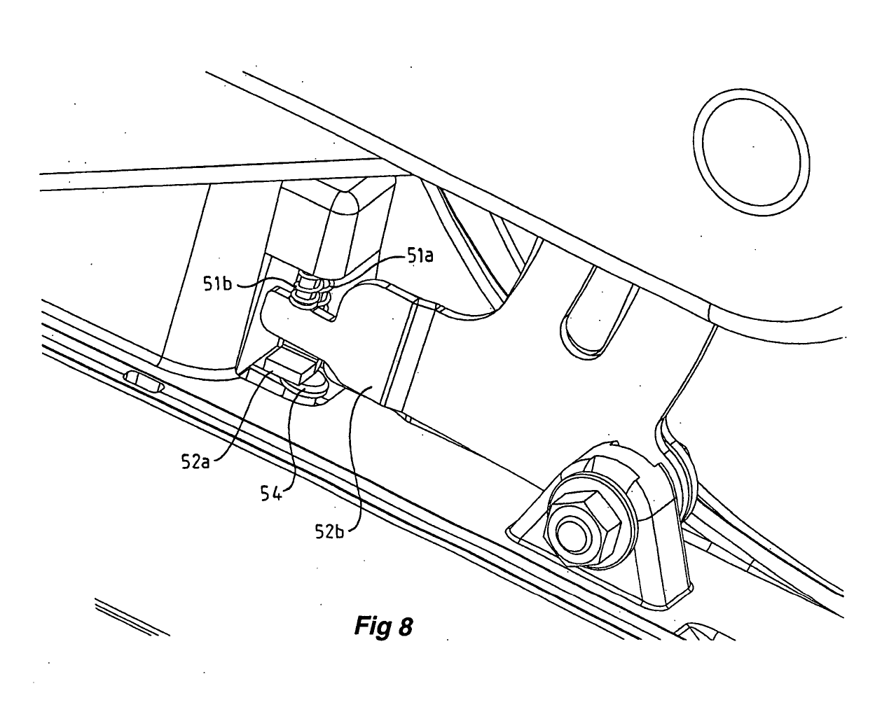

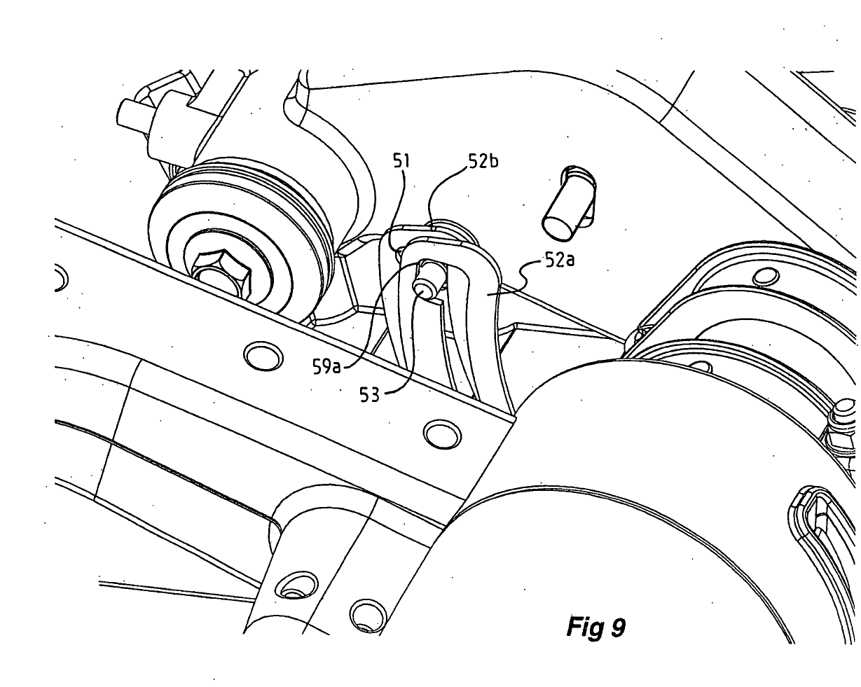

FIGS. 8 and 9 show the first locking means of FIGS. 6 and 7 in a partially locked condition.

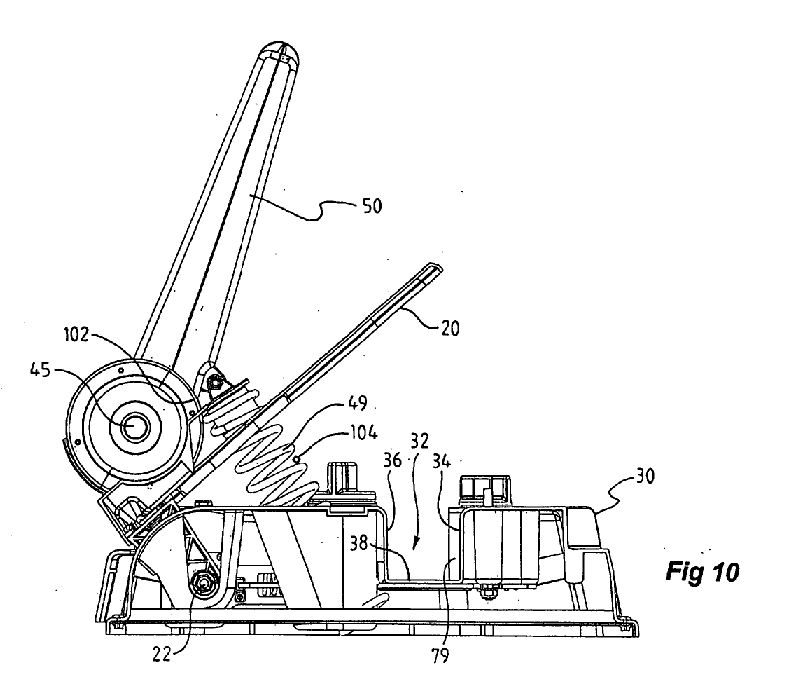

FIGS. 10 to 13 show components of the saw assembly of FIG. 1 in a partial cutaway cross-sectional view with the arm and head moving from a fully raised to a fully lowered position. These Figs show the progressive action of a second locking means.

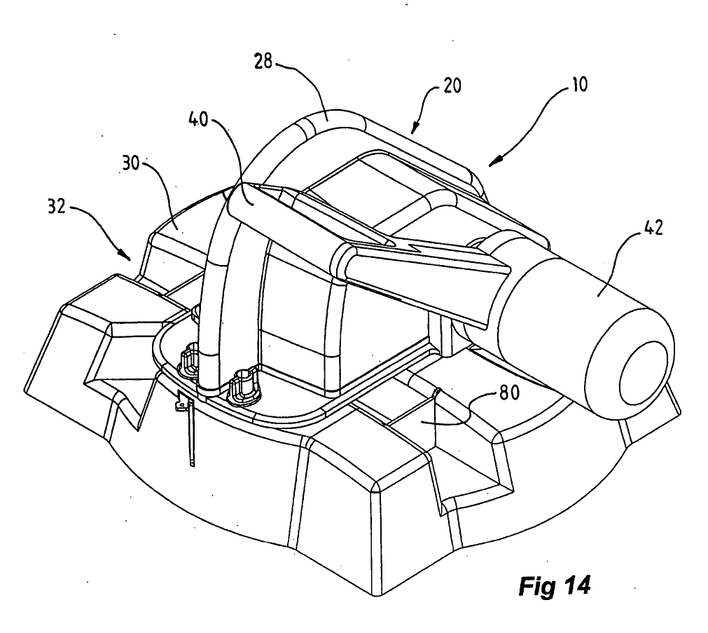

FIG. 14 shows a perspective view of a guarded power circular saw assembly according to a second embodiment of the invention with its head down but the blade still in its raised position.

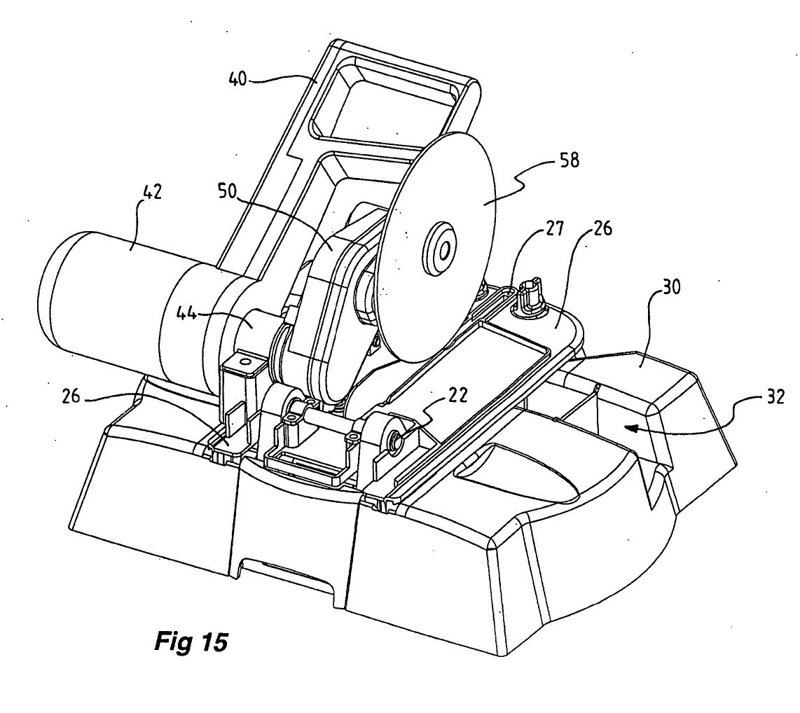

FIG. 15 shows the saw assembly of FIG. 14 in the same configuration but with the blade cover removed.

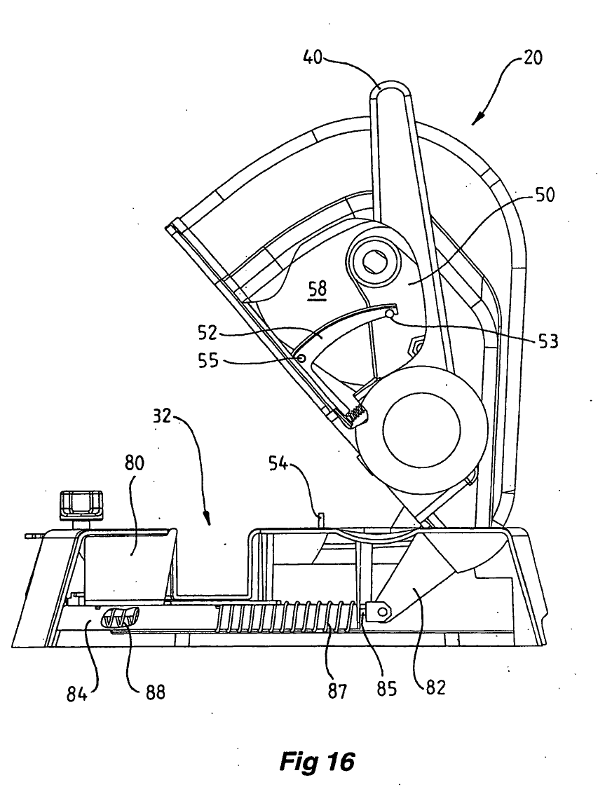

FIG. 16 shows a sectional view of the saw assembly of FIGS. 14 and 15 with the head raised ready for loading a work-piece.

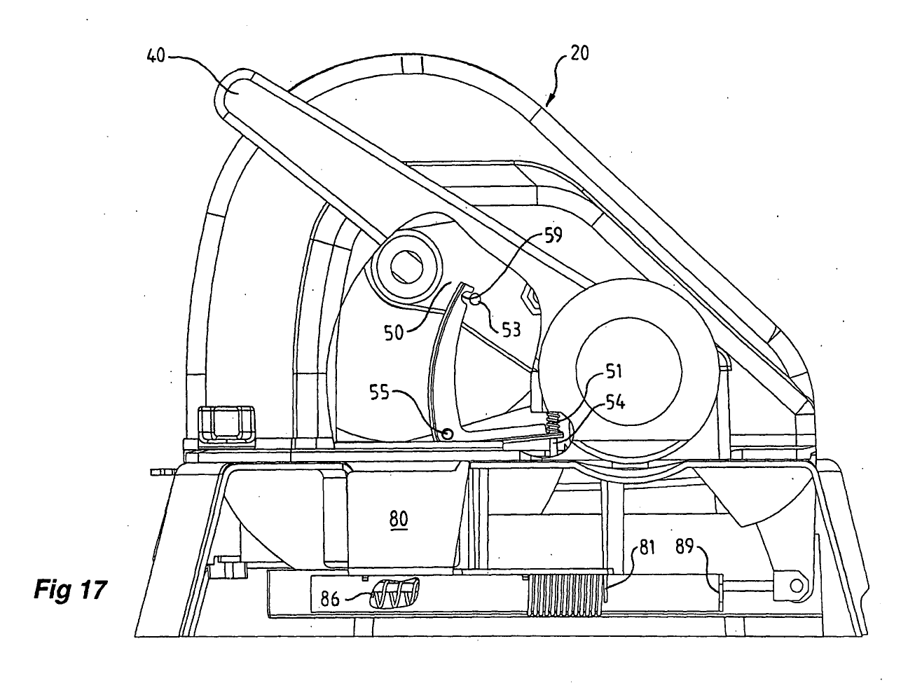

FIG. 17 is a view of the saw assembly similar to FIG. 16 but with the head lowered and the blade ready to cut.

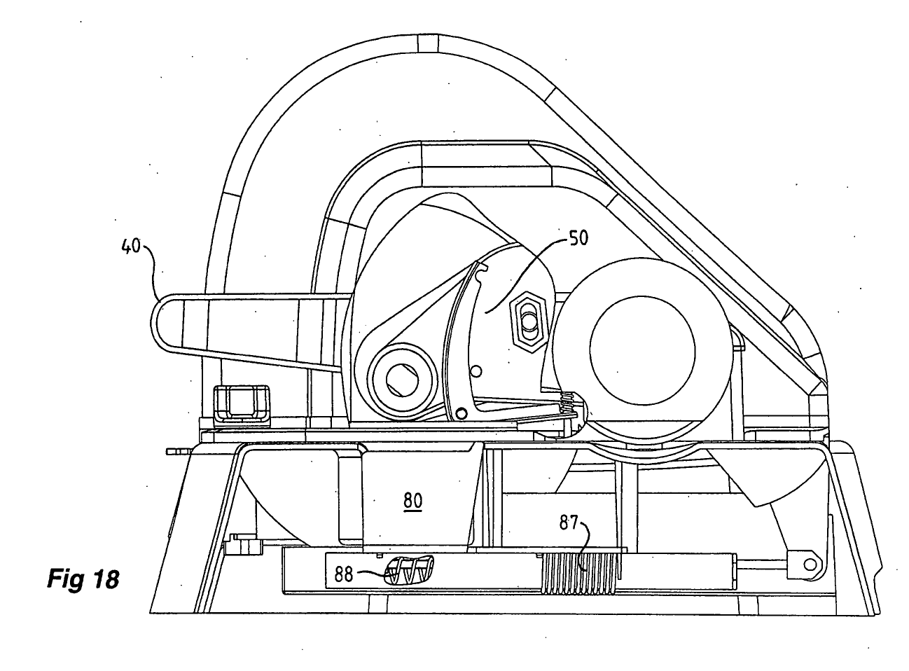

FIG. 18 is a similar view to that of FIG. 17 but with the head and blade lowered.

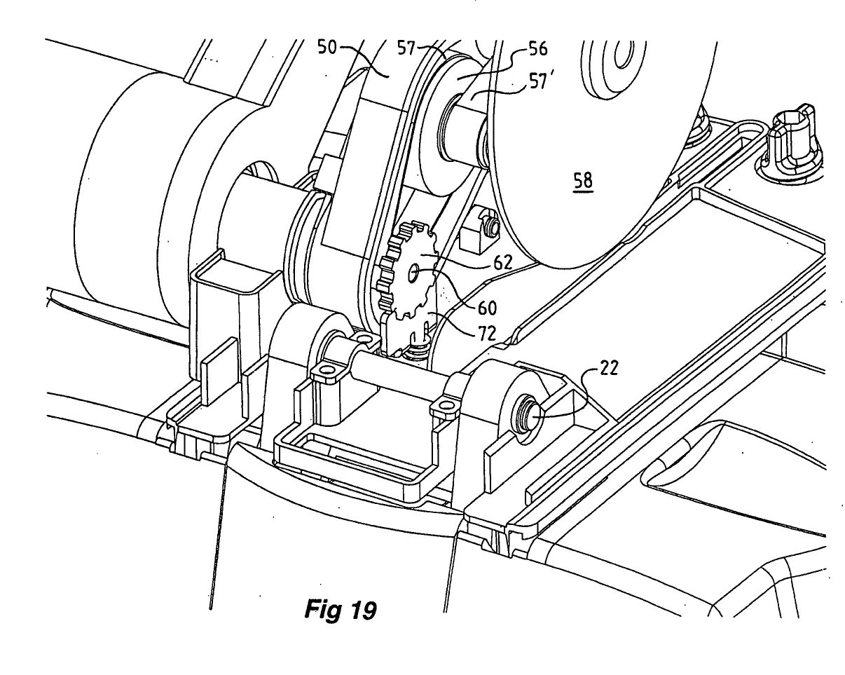

FIG. 19 is a similar view to that of FIG. 15 enlarged with the drive arm belt cover removed showing the blade drive train and spindle lock.

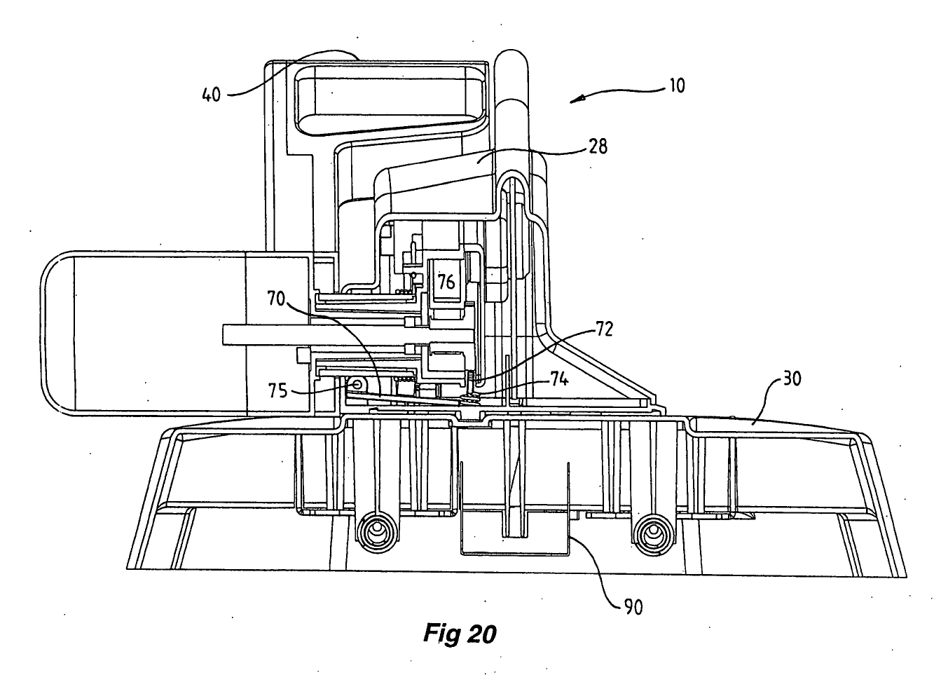

FIG. 20 is a longitudinal section of the saw assembly of FIGS. 14 to 19 showing the blade cover still fitted and the spindle lock disengaged.

### FIRST EMBODIMENT OF THE INVENTION

Referring to FIG. 1, a guarded power circular saw 10 according to a first embodiment of the invention has a base 30 with a channel 32 for receiving a work-piece extending therethrough and a head 20 for supporting the drive motor and the saw blade. The head 20 is mounted to base 30 for movement through an arc about a primary axis 22 (shown in FIG. 10) from a raised position above the base 30 to a lowered position engaging the base 30.

The drive motor is housed within motor housing 42. A single handle 40 is provided for performing the functions of lowering the head 20 while semi-automatically applying a clamp to the work-piece and rotating the saw out from the head to cut the work-piece.

The head 20 includes a removable cover 28 to allow access and replacement of the saw blade 58 as shown in FIG. 5.

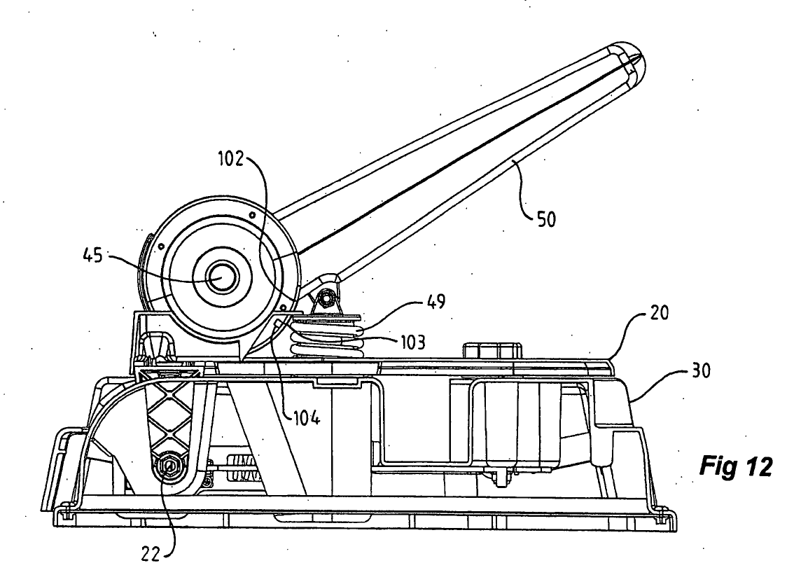

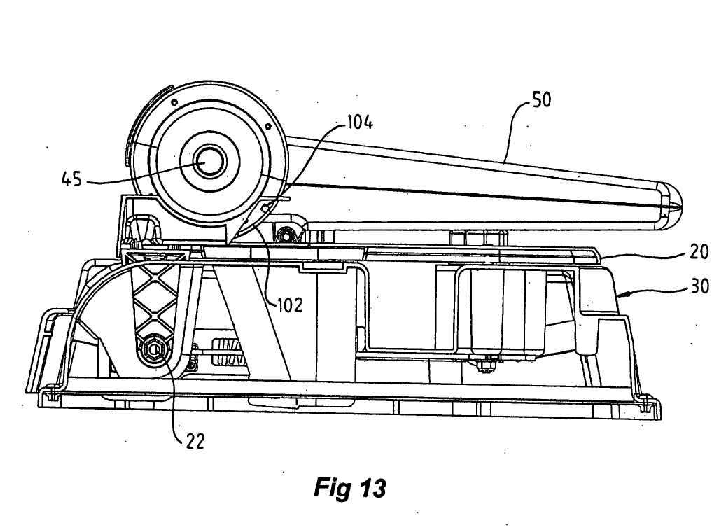

Referring to FIGS. 4a, 4b and 5, the head 20 is shown in its down (lowered) position with its base plate 26 in contact with the base 30. FIG. 5 shows that handle 40 is operatively connected to a drive arm 50 by a spigot that extends from the drive motor housing 42 and these two components are pivotally mounted to the head base plate 26 by arm pivot bracket 44 for rotation about a secondary point axis 45 (best shown in FIGS. 12 and 13). A drive arm return spring 49 is provided to bias the drive arm upwards.

From the position shown in FIGS. 4a and 5, an operator can further rotate handle 40 towards the work-piece within channel 32 to rotate arm 50 and hence blade 58 out through slot 27 within head base plate 26 to engage and cut the work-piece as shown in FIG. 4b.

Referring to FIG. 1, the saw assembly is shown in its at rest position with head raised. In this position channel 32 is exposed ready to receive a work-piece. In this position the saw blade 58 cannot exit the head 20. More specifically the blade 58 cannot move out through the head base plate 26 through slot 27 (shown in FIG. 5).

The mechanism for preventing the blade 58 moving prematurely with respect to the head 20 is as follows. Blade 58 is mounted on drive arm 50 (shown in FIG. 5). A first latch member in the form of a retaining pin 53 extends from drive arm 50 (as shown in FIG. 7) to form part of a first locking means operatively interposed between the head 20 and the arm 50. The first locking means includes a primary latch arm 52b mounted to the head base plate 26 by a pivot 55 (refer FIGS. 6 and 7). Latch arm 52b has a notch 59b (shown in FIG. 9) that engages retaining pin 53 to lock the head 20 to the arm 50. A latch arm release pin 54 is mounted to the base 30 as shown in FIG. 3. Once the head 20 has been lowered onto the base 30 by the operator depressing handle 40 as shown in FIG. 4a, the latch arm release pin 54 holds an end of the latch arm 52b up against return spring 51. In this position, the latch arm 52b is slightly rotated about pivot 55 such that notch 59 releases pin 53 so that further movement of handle 40 downwards towards the base 30 causes arm 50 and therefore blade 58 to exit the head 20 through slot 27 within base plate 26 towards the work-piece as is progressively shown by FIGS. 12 and then 13.

The first locking means operatively interposed between the head 20 and the arm 50, described above, ensures that the blade 58 cannot exit the head 20 until the head base plate 26 has closed over the base 30. This ensures that the operator cannot inadvertently bring the blade into contact with the operators' hands or fingers. While the locking means described above incorporates a primary latch arm 52b mounted to the head base plate 26 by a pivot mount 55, other locking means may be used.

The first locking means described so far will not prevent an operator raising the head 20 after the head 20 has engaged the base 30 and the blade 58 has exited the head. It is possible that an operator may attempt to lift the head 20 during cutting of a work-piece. In order to prevent this, a second locking means is provided.

The second locking means is best shown in FIGS. 10 through to 13. The second locking means is operatively interposed between the head 20 and the base 30. The second locking means comprises an arcuate locking wall 102 depending from the arm 50 and a projection in the form of a pin 104 extending from the base 30. The pin 104 and wall 102 are co-operably arranged to prevent raising of the head 20 during the cut. This co-operable arrangement is such that movement of the locking wall 102 about the primary pivot axis 22 cannot occur after the head is engaged the base 30 and the arm 50 has commenced rotation with respect to the head about the secondary pivot axis 45. This is clearly evidenced in FIG. 13 which shows that if an attempt is made to lift the head 20, the arcuate locking wall 102 will foul the pin 104 because of the relative positioning of the primary axis 22 and the secondary axis 45.

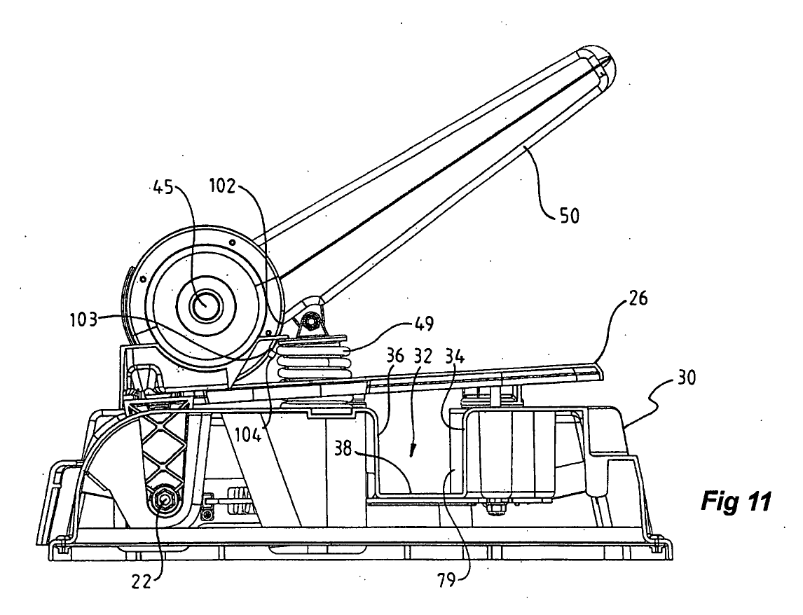

With the locking arrangements described thus far, there is a small angular delay during which the primary locking means has unlocked and before the secondary locking means has locked. In order to enable the movement of the head 20 with respect to the base 30 from the position shown in FIG. 11 to the position shown in FIG. 12, it is necessary to provide clearance between the end of 103 of the arcuate locking wall 102 and the pin 104. Referring now to FIG. 12, it can be seen that because of this clearance, movement of the arcuate locking wall with respect to the primary pivot axis 22 is not restrained during initial movement of the arm 50 downwards towards the base 30. Thus, with the first locking means unlocked (since primary latch arm 52b has moved into the position shown in FIG. 9 freeing pin 53 from recess 59b) it would be possible for the blade 58 to be exposed without the head 20 being locked to the base 30. In order to deal with the possibility of the head 20 being lifted with respect to the base 30 during this delay period, an intermediate locking means having a supplementary latch arm 52a is provided as shown in FIGS. 7 to 9.

If the head 20 is manually lifted away from the base 30 during the delay period and before the second locking means is operative, the supplementary latch arm 52a of the intermediate locking means will return to the locked position shown in FIG. 9. It is able to return to its locked position because of the extra length of the recess 59a (as compared to recess 59b). This movement of the supplementary latch arm 52a is caused by spring 51a as soon as the head is lifted a small amount away from arm lock release pin 54 mounted to the base 30 as shown in FIG. 8. As a result, exposure of the blade 58 is not possible even though the primary latch 52b is not effective once relative movement has occurred between the arm 50 and the head 20.

The saw assembly 10 as described above can be used to cut various materials with the correct selection of saw blade 58. It is envisaged that the saw assembly 10 will be particularly appropriate for cutting steel. When cutting steel with a conventional circular saw the operator faces the hazard of small sharp steel cuttings (or swarf) travelling at high velocity from the region of the blade. However with the above described saw assembly 10, the blade is sufficiently enclosed to prevent swarf escaping.

When sawing a work-piece, it is generally desirable to have the work-piece firmly clamped to a support base. This is particularly the case when cutting steel as the effect of an unclamped work-piece twisting during cutting can be serious in terms of blade damage. Therefore in the above described first embodiment of the invention there is provided a channel 32 recessed within the base 30. Referring to FIGS. 1, 10 and 11 it can be seen that the channel 32 is defined by a pair of parallel spaced apart walls 34 and 36 joined at their lower sides by a channel floor 38. Associated with the channel 32 are a pair of clamps 80 (shown in FIG. 5) which semi-automatically clamp the work-piece in position within channel 32 as the head 20 is lowered.

A semi-automatic clamping system is illustrated in FIGS. 1 and 2. This system allows for multiple cutting of the same cross-section work-piece without any clamp adjustment required, once the clamps have been pre-adjusted for that particular cross-section.

Two identical clamp mechanisms are employed. One is provided for the work-piece and the other is provided for the off-cut. Each has an identical interlock assembly. FIGS. 10 and 11 show movement of the clamp blades 83 through the first wall 34 of the channel 32 towards the second channel wall 36.

Again, referring to FIGS. 1 and 2, each clamp 80 comprises a work-piece clamp body and an adjustment knob 81. The adjustment knobs 81 allow loosening of the clamp bodies 82 so that they can be pushed against the work-piece in an initial position. This initial position, which can allow up to 1 mm of clearance, can then be locked by tightening knobs 81.

An eccentric crank 85 mounted around the head pivot shaft 22, together with a linkage assembly 83 connected to the clamp body 82 as shown in FIG. 2 is provided to facilitate automatic clamping. The linkage assembly 83 is made up of two halves or portions 83a and 83b which are joined by a compression spring 86. The spring 86 provides the “give” allowing full movement of the head 20 and the eccentric crank 85 to go “over centre” to lock the clamps 80 without the clamp force operating to raise the head again.

When correctly adjusted there is very little movement of the work-piece clamps 80 (only a few millimetres at most). Given that the movement of the first portion 83b will always be the same under the action of the eccentric crank 85, where the movement of the work-piece clamp and hence the second portion 83a is small, there will be significant compression of the spring 86, resulting in a significant clamping force being applied to the work-piece.

Interlocks are provided to prevent the cut proceeding (with possible blade damage) if the clamps 80 are not adequately pre-adjusted. The interlocking arrangement is shown in FIGS. 2 and 3. When a work-piece is adequately clamped, the compression spring 86 between the link halves 83a and 83b undergo significant compression and therefore, the link 83a moves only a small distance. Alternatively, if the work-piece is not adequately clamped, link half 83a will move a significant distance before compression of the spring 86 occurs.

Again, referring to FIG. 2, it can be seen that linear movement of the link 83a will result in rotary movement of cam 87. When the clamp 80 is in the release position, blocking pin 88, which is spring loaded upwards and shown in FIG. 2 in a pushed down state, is free to be pushed down. If the link 83a moves forward to a significant extent, cam 87 will rotate to a position which prevents the descent of pin 88. As explained above, link 83a will move forward a significant amount only when the work-piece is not adequately clamped due to failure to correctly pre-adjust the clamp position.

If pin 88 is locked up by the blocking surface provided by cam 87, the projecting pins 88, as shown in FIG. 1, prevent the head from being fully lowered, thus preventing the cut from proceeding. This configuration is illustrated in FIG. 3 in which it can be clearly seen that pins 88 are preventing the further lowering of the head base plate 26. In contrast, the fully lowered position, only achievable when a work-piece has been adequately clamped, is illustrated in FIGS. 4a and 4b.

In the event that only one clamp 80 can be used, for instance when trimming a short off-cut from a work-piece, the clamp 80 on the off-cut side is adjusted to abut the second wall 36 of channel 32 (rear face of the trough) instead of the work-piece. This will satisfy the interlock conditions and has the added advantage of closing a potential swarf leakage path.

The pair of clamps 80, positioned either side of the blade 58, ensure that both the work-piece and off-cut are securely held during cutting and until the saw blade 58 is retracted.

### SECOND EMBODIMENT OF THE INVENTION

Referring to FIG. 14 a guarded power circular saw 10 according to a second embodiment of the invention has a base 30 with a channel 32 for receiving a work-piece extending therethrough and a head 20 for supporting the drive motor and the saw blade. The drive motor is housed within motor housing 42. A single handle 40 is provided for performing the functions of lowering the head while automatically applying a clamp to the work-piece and rotating the saw out from the head to cut the work-piece.

The head 20 includes a removable cover 28 to allow access and replacement of the saw blade 58 as shown in FIG. 15.

Referring to FIG. 15, the head 20 is shown in its down (lowered) position with its base plate 26 in contact with the base 30. Handle 40 is operatively connected to a drive arm 50 by a spigot that extends from the drive motor housing 42 and these two components are pivotally mounted to the head base plate 26 by arm pivot bracket 44.

From the position shown in FIG. 15, an operator can further rotate handle 40 towards the work-piece within channel 32 to rotate arm 50 and hence blade 58 out through slot 27 within head base plate 26 to engage and cut the work-piece.

Referring to FIG. 16, the saw assembly is shown in its at rest position with head raised. In this position channel 32 is exposed ready to receive a work-piece. In this position the saw blade 58 cannot exit the head 20. More specifically the blade 58 cannot move out through the head base plate 26 through slot 27 (shown in FIG. 15). The mechanism for preventing the blade 58 moving with respect to the head 20 is as follows. Blade 58 is mounted on drive arm 50. A arm lock retaining pin 53 extends from drive arm 50 to form part of a locking means operatively interposed between the head 20 and the arm 50. The locking means is in the form of an arm lock 52 mounted to the head base plate 26 by a pivot 55. Arm lock 52 has a notch 59 (shown in FIG. 17) that engages retaining pin 53 to lock the head 20 to the arm 50. An arm lock release pin 54 is mounted to the base 30 as shown in FIG. 3. Once the head 20 has been lowered onto the base 32 by the operator depressing handle 40 as shown in FIG. 17, the arm lock release pin 54 holds an end of the arm lock 52 up against return spring 51. In this position, the arm 52 is slightly rotated about pivot 55 such that notch 59 releases pin 53 so that further movement of handle 40 downwards towards the base 30 causes arm 50 and therefore blade 58 to exit the head 20 through slot 27 within base plate 26 towards the work-piece as is progressively shown by FIGS. 17 and then 18.

The locking means operatively interposed between the head and the arm, described above, ensures that the blade 58 cannot exit the head 20 until the head base plate 26 has closed over the base 30. This ensures that the operator cannot inadvertently bring the blade into contact with the operators' hands or fingers. While the locking means described above incorporates an arm lock 52 mounted to the head base plate 26 by a pivot mount 55, other locking means may be used.

In addition to having a locking means operatively interposed between the head 20 and the arm 50, the saw assembly 10 also has a means for locking the motor drive shaft 60 as shown in FIG. 19. The means for locking the drive shaft 60 is, in this embodiment, a drive shaft pinion 62 and a drive shaft lock 70.

Drive shaft lock 70 is best shown in FIG. 20. It comprises a pinion stop 72 pivotally mounted at 75 to the head base plate 26. A spring 74 is provided to bias the pinion stop 72 upwards into engagement with the drive shaft pinion 62. In this position the drive shaft 60 cannot rotate and therefore, even if the drive motor is started, the saw will not rotate.

A drive shaft release finger extends from the underside of the head cover 28 (not shown). This finger depresses the drive shaft lock 70 in the region indicated arrow 76 in FIG. 20 against the bias of spring 74. Thus, in the position shown in FIG. 20, the pinion 62 and hence shaft 60 is free to rotate, but as soon as the head cover 28 is removed from the head, spring 74 lifts pinion stop 72 into engagement with pinion 62 to lock the shaft 60.

The saw assembly 10 as described above can be used to cut various materials with the correct selection of saw blade 58. It is envisaged that the saw assembly 10 will be particularly appropriate for cutting steel. When cutting steel with a conventional circular saw the operator faces the hazard of small sharp steel cuttings (or swarf) travelling at high velocity from the region of the blade. However with the above described saw assembly 10, the blade is sufficiently enclosed to prevent swarf escaping. Instead the swarf is caught in a sliding draw 90 as shown in FIG. 20.

When sawing a work-piece, it is generally desirable to have the work-piece firmly clamped to a support base. This is particularly the case when cutting steel as the effect of an unclamped work-piece twisting during cutting can be serious in terms of blade damage. Therefore in the above described embodiment of the invention there is provided a pair of clamps 80 which automatically clamps the work-piece in position within channel 32 as the head 20 is lowered.

The progressive operation of one of the two clamps 80 can be seen most dearly in FIGS. 16, 17 and 18. In FIG. 16, the head 20 is in its fully raised position and clamp actuating leg 82 is positioned such that both clamp return spring 87 and clamp over travel springs 88 are in a free substantially uncompressed state. As the head 20 is lowered by pulling on handle 40 the clamp actuating leg 82 rotates thereby pulling clamp rod 85 which produces a force in over travel spring 88 which in turn acts on the inside of the end 89 of the clamp tube 84 to move the clamp tube 84 to the right of FIG. 16 thereby moving clamp 80 in the same direction towards the work-piece in channel 32.

Over travel spring 88 has a relatively high (shift) spring rate compared to that of clamp return spring 87. Therefore, as the head 20 is lowered the clamp return spring 87 is first compressed. Once the work-piece is engaged by the clamp 80 the over travel spring 88 is compressed ensuring a substantial clamping force is applied to the work-piece. Because the clamp actuating leg 82 is connected to the head 20 rather that the handle 40, no additional force is applied to the work-piece once the head is in its fully lowered position as shown in FIG. 17. That is as the handle 40 is lowered from its position shown in FIG. 17 to its position shown in FIG. 5 no additional force is applied to the work-piece. In other words, full clamping force is applied to the work-piece before the blade 58 is released from the head 20.

The pair of clamps 80, positioned either side of the blade 58, ensure that both the work-piece and off-cut are securely held during cutting and until the saw blade 58 is retracted. The clamp 80 on the off-cut side has two parallel spaced apart blades. The first of these blades is positioned close to the saw blade 58 and the second is further along the channel 32 as shown clearly in FIG. 14. This enables both small and large off-cut pieces to be securely held during and immediately after cutting.

With both of the above-described embodiments, the saw blade is always positioned out of reach of the operator so as to eliminate, or at least reduce, the possibility of injury. Initially the saw blade is enclosed within the head in its raised position. Unlike other drop saws, there is no progressive exposure of the blade as the head is lowered towards the work-piece. It is not until the head engages the base that the locking means are released to allow the arm, and hence the blade, to be lowered with respect to the head. With the head engaged with the base, it is not possible for the operator to place his hands or fingers in the path of the blade.

For both of the above-described embodiments, the drive train between blade 58 and the drive shaft 60 is shown most clearly in FIG. 19. Drive shaft 60 has a pulley which drives a toothed belt 57. An idler pulley 56 is provided between drive shaft 60 and the mount for blade 58 (not shown). A second toothed belt 57′ is provided to transmit power from the idler pulley 56 to the mount for blade 58. Other drive train arrangements may be used. For instance direct drive through gearing may be used.

While the present invention has been described in terms of preferred embodiments in order to facilitate better understanding of the invention, it should be appreciated that various modifications can be made without departing from the principles of the invention. Therefore, the invention should be understood to include all such modifications within its scope.

1. A guarded power saw assembly comprising:
a base for supporting a work-piece;
a circular saw blade;
a drive motor operatively connected to the saw blade;
a head supporting both the drive motor and the saw blade, with the head mounted to the base for movement through an arc about a primary pivot axis from a raised position above the base to a lowered position engaging the base;
an arm having a proximal end and a distal end, the proximal end mounted to the head for movement through an arc about a secondary pivot axis and the distal end supporting the circular saw blade;
a first locking means operatively interposed between the head and arm, the first locking means having a locked condition in which the arm is locked to the head so as to keep the saw blade enclosed by the head and an unlocked position in which the arm is pivotally movable with respect to the head to allow a portion of the blade to exit the head; and
a handle extending from the head and operatively connected to the arm, wherein the handle is movable to first rotate the locked together head and arm with respect to the base towards the work-piece and, after the head has engaged the base, to then pivot the arm with respect to the head such that the saw blade exits the head to cut the work-piece.

2. An assembly as claimed in claim 1 further comprising a second locking means operatively interposed between the head and the base, the second locking means having an unlocked condition in which the head is pivotally movable with respect to the base and having a locked condition in which the head is locked to the base after the head has engaged the base and the arm has commenced rotation with respect to the head.

3. An assembly as claimed in claim 2 further comprising an intermediate locking means operatively interposed between the head and the arm, the intermediate locking means operable to lock the arm to the head when an attempt is made to lift the head away from engagement with the base,
wherein the intermediate locking means is operable after the first locking means has unlocked and prior to the second locking means engaging.

4. An assembly as claimed in claim 3 wherein the base has a work-piece receiving recessed channel, the channel defined by a pair of spaced apart parallel first and second channel walls joined at their lower sides by a channel floor,
wherein the channel is longitudinally disposed perpendicular to the plane of the blade.

5. An assembly as claimed in claim 4 wherein the assembly includes a work-piece clamp assembly.

6. An assembly as claimed in claim 5 wherein, after initial pre-adjustment of the clamp assembly, the clamp assembly is automatically actuated as the head is lowered towards the work-piece.

7. An assembly as claimed in claim 6 wherein the clamp assembly comprises:
a pair of work-piece clamps each slidably mounted for movement across the channel through respective spaced apart slots in the first channel wall towards the second channel wall, the clamps spaced apart for clamping the work-piece on respective sides of the blade; and
a pair of respective clamp mechanisms, each operably connected between the head and its respective clamp,
whereby, as the head is lowered towards the base, the clamp mechanisms move the clamps across the channel to clamp a work-piece located in the channel.

8. An assembly as claimed in claim 7 wherein each clamp mechanism comprises:
a linkage assembly operably connecting the clamp to the head; and
an adjusting means for adjusting the position of the clamp with respect to the linkage assembly in a direction across the channel,
wherein the adjusting means of a first of the clamp mechanisms allow its clamp to be moved to a pre-adjusted position adjacent or abutting the work-piece and the adjusting means of a second of the clamp mechanisms allow its clamp to be moved to a pre-adjusted position adjacent or abutting the work-piece or the second channel wall.

9. An assembly as claimed in claim 8 further comprising a work-piece clamp interlock means for preventing the commencement of sawing,
wherein the interlock means disengages to allow the commencement of sawing as the locked together head and arm rotates towards the work-piece only when both work-piece clamps have been moved to their pre-adjusted positions.

10. An assembly as claimed in claim 9 wherein each linkage assembly comprises:
a first portion;
a second portion overlapping the first portion to define an overlapping portion; and
a compression spring mounted within the overlapping portion for compression when the pre-adjusted clamp is actuated to engage a work-piece or the second channel wall.

11. An assembly as claimed in claim 10 wherein the interlock means comprises a blocking means for preventing the head being lowered sufficiently towards the base to allow disengagement of the first locking means, the blocking means having a blocking surface operably connected the second portion of the linkage assembly,
wherein, in use, if both clamps are not in their said pre-adjusted positions, the blocking surface moves to a position preventing the head being lowered sufficiently towards the base to allow disengagement of the first locking means.

12. An assembly as claimed in claim 11 wherein the blocking means further comprises a pin positioned between the head and the blocking surface, the blocking pin held up by the blocking surface to prevent the head being lowered sufficiently towards the base to allow disengagement of the first locking means when either clamps is not in its said pre-adjusted position.

13. An assembly as claimed in claim 12 wherein the head has a removable cover shaped to guard the blade.

14. An assembly as claimed in claim 13 wherein the primary and secondary pivot axes are parallel and spaced apart.

15. A guarded power saw assembly comprising;
a base for supporting a work-piece;
a circular saw blade;
a drive motor operatively connected to the saw blade;
a head supporting both the drive motor and the saw blade, with the head mounted to the base for movement through an arc about a primary pivot axis from a raised position above the base to a lowered position engaging the base;
an arm having a proximal end and a distal end, the proximal end mounted to the head for movement through an arc about a secondary pivot axis and the distal end supporting the circular saw blade;
a first locking means having a first latch member mounted to the arm and a second latch member mounted to the head for movement with respect to the head and lockingly co-operable with the first latch member, the first locking means having a locked condition in which the arm is locked to the head so as to keep the saw blade enclosed by the head and an unlocked position in which the arm is pivotally movable with respect to the head to allow a portion of the blade to exit the head; and
a handle extending from the head and operatively connected to the arm, the handle movable to first rotate the locked together head and arm with respect to the base towards the work-piece and, after the head has engaged the base, to then pivot the arm with respect to the head such that the saw blade exits the head to cut the work-piece,
whereby the first locking means is unlocked by movement of the second latch member as it engages a base-depending member when the head engages the base.

16. An assembly as claimed in claim 15 wherein the first latch member comprises a pin and the second latch member comprises a pivotally mounted primary latch arm, the primary latch arm having a primary recess shaped and positioned to lockably receive the pin.

17. An assembly as claimed in claim 16 wherein the primary latch arm is biased to move the primary recess towards the pin.

18. An assembly as claimed in claim 17 further comprising:
a second locking means operatively interposed between the head and the base, the second locking means having an unlocked condition in which the head is pivotally movable with respect to the base and having a locked condition in which the head is locked to the base after the head has engaged the base and the arm has commenced rotation with respect to the head.

19. An assembly as claimed in claim 18 wherein the second locking means comprises:
a locking wall depending from the arm or handle;
a projection extending from the base,
wherein the projection and locking wall are co-operably arranged to prevent, or substantially limit, movement of the locking wall about the primary pivot axis, thereby preventing, or substantially limiting, movement of the head with respect to the base, after the head has engaged the base and the arm has commenced rotation with respect to the head about the secondary pivot axis.

20. An assembly as claimed in claim 19 wherein the locking wall is arcuate having a centre of radius coincident, lying on, or adjacent to the secondary pivot axis.

21. An assembly as claimed in claim 20 further comprising an intermediate locking means operatively interposed between the head and the arm, the intermediate locking means operable to lock the arm to the head when an attempt is made to lift the head away from engagement with the base,
wherein the intermediate locking means is operable after the first locking means has unlocked and prior to the second locking means engaging.

22. An assembly as claimed in claim 21 wherein the intermediate locking means comprises:
the pin mounted to the arm; and
a supplementary latch member pivotally mounted to the head for movement with respect to the head and lockingly co-operable with the pin, the supplementary latch arm having an supplementary recess shaped and positioned to lockably receive the pin, the supplementary latch arm biased to move the supplementary recess towards the pin,
whereby the intermediate locking means is unlocked by movement of the supplementary latch member as it engages the base-depending member when the head engages the base but will re-lock, due to extra length within the supplementary recess, if the an attempt is made to lift the head after the first locking means has unlocked and prior to the second locking means engaging.

23. An assembly as claimed in claim 22 wherein the base has a work-piece receiving recessed channel, the channel defined by a pair of spaced apart parallel first and second channel walls joined at their lower sides by a channel floor,
wherein the channel is longitudinally disposed perpendicular to the plane of the blade.

24. An assembly as claimed in claim 23 wherein the assembly includes a work-piece clamp assembly.

25. An assembly as claimed in claim 24 wherein, after initial pre-adjustment of the clamp assembly, the clamp assembly is automatically actuated as the head is lowered towards the work-piece.

26. An assembly as claimed in claim 25 wherein the clamp assembly comprises:
a pair of work-piece clamps each slidably mounted for movement across the channel through respective spaced apart slots in the first channel wall towards the second channel wall, the clamps spaced apart for clamping the work-piece on respective sides of the blade; and
a pair of respective clamp mechanisms, each operably connected between the head and its respective clamp,
whereby, as the head is lowered towards the base, the clamp mechanisms move the clamps across the channel to clamp a work-piece located in the channel.

27. An assembly as claimed in claim 26 wherein each clamp mechanism comprises:
a linkage assembly operably connecting the clamp to the head; and
an adjusting means for adjusting the position of the clamp with respect to the linkage assembly in a direction across the channel,
wherein the adjusting means of a first of the clamp mechanisms allow its clamp to be moved to a pre-adjusted position adjacent or abutting the work-piece and the adjusting means of a second of the clamp mechanisms allow its clamp to be moved to a pre-adjusted position adjacent or abutting or the second channel wall.

28. An assembly as claimed in claim 27 further comprising a work-piece clamp interlock means for preventing the commencement of sawing,
wherein the interlock means disengages to allow the commencement of sawing as the locked together head and arm rotates towards the work-piece only when both work-piece clamps have been moved to their pre-adjusted positions.

29. An assembly as claimed in claim 28 wherein each linkage assembly comprises:
a first portion;
a second portion overlapping the first portion to define an overlapping portion; and
a compression spring mounted within the overlapping portion for compression when the pre-adjusted clamp is actuated to engage a work-piece or the second channel wall.

30. An assembly as claimed in claim 29 wherein the interlock means comprises a blocking means for preventing the head being lowered sufficiently towards the base to allow disengagement of the first locking means, the blocking means having a blocking surface operably connected the second portion of the linkage assembly,
wherein, in use, if both clamps are not in their said pre-adjusted positions, the blocking surface moves to a position preventing the head being lowered sufficiently towards the base to allow disengagement of the first locking means.

31. An assembly as claimed in claim 30 wherein the blocking means further comprises a pin positioned between the head and the blocking surface, the blocking pin held up by the blocking surface to prevent the head being lowered sufficiently towards the base to allow disengagement of the first locking means when either clamps is not in its said pre-adjusted position.

32. An assembly as claimed in claim 31 wherein the head has a removable cover shaped to guard the blade.

33. An assembly as claimed in claim 32 wherein the primary and secondary pivot axes are parallel and spaced apart.

34. A guarded power saw assembly substantially as hereinbefore described with reference to FIGS. 1 to 13.

35. A guarded power saw assembly substantially as hereinbefore described with reference to FIGS. 14 to 20.
